(19) United States
(12) Patent Application Publication
(10) Pub. No.: US 2009/0120123 A1
(43) Pub. Date: May 14, 2009

(54) Refrigerator unit and/or freezer unit

(76) Inventors: Viktor Laube, Ochsenhausen (DE); Klaus Oelmaier, Ochsenhausen (DE)

Correspondence Address: DILWORTH & BARRESE, LLP, 333 EARLE OVINGTON BLVD., SUITE 702, UNIONDALE, NY, 11553, US

(21) Appl. No.: 12/287,235

(22) Filed: Oct. 7, 2008

(30) Foreign Application Priority Data
Oct. 8, 2007 (DE) 202007014026.6
Dec. 19, 2007 (DE) 202007017691.0

(51) Int. Cl. F25D 17/06; G05B 15/00

(52) U.S. Cl. 62/426; 700/275

(57) ABSTRACT

The invention relates to a refrigerator unit and/or a freezer unit comprising a unit base and a fan for the generation of an airflow in the unit base, wherein the unit has a control or regulation unit by means of which the speed and/or the direction of rotation of the fan can be changed.

The present invention relates to a refrigerator unit and/or a freezer unit having a unit base and a fan for the generation of an airflow in the unit base.

Refrigerator units are known from the prior art which have a so-called assembly carrier which is arranged in the region of the unit base and on which components are arranged which serve the cold generation. These components are, for example, a compressor, a condenser as well as a fan which has the task of generating an airflow in the region of the unit base. Such an airflow can be necessary, for example, to dissipate heat from the condenser, the compressor or other components or to increase the evaporation performance of the evaporation tray by transporting humid air away.

In units known from the prior art, the fan is operated at a fixed, that is, unchangeable, speed.

It is the underlying object of the present invention to further develop a refrigerator unit and/or freezer unit of the initially named kind such that its operation has greater flexibility with respect to previously known units.

This object is solved by a refrigerator unit and/or a freezer unit having the features of claim 1. Provision is accordingly made that the unit has a control or regulation unit which is directly or indirectly in communication with the fan and by means of which the speed and/or the direction of rotation of the fan can be changed. Provision is thus made in accordance with the invention that the speed and/or the direction of rotation of the fan is not constant in time, but is rather changeable, and indeed preferably in dependence on the required refrigeration capacity.

Such a change of speed and/or direction of rotation can take place, for example, in accordance with a preset schedule, i.e. in accordance with stored values. Accordingly, provision can be made, for example, that a higher speed of the fan is selected during the day due to the more frequent opening of the door and thus, due to the greater heat input than is the case at night.

The stored values according to which speed and/or direction of rotation are changed can, for example, be fixedly preset or can also be changed by a user of the unit.

Provision is made in a preferred embodiment of the invention that the unit comprises detection means for the detection of at least on parameter and that the control or regulation unit is made such that it changes the speed and/or the direction of rotation of the fan in dependence on this at least one measured parameter. It is possible in this manner to match the air volume flow or the flow direction of the air to different operating states. The noise level caused by the fan and by the air flow also changes in dependence on the air volume flow. The optimum selected speed and direction of rotation can thereby be set with respect to noise, refrigeration capacity and energy consumption for every operating state.

It is, for example, conceivable that the fan speed and thus also the noise level can be reduced accordingly in operating states in which a low refrigeration capacity is required.

Provision can furthermore be made that a higher energy conversion is achieved at the condenser in operating states with a high refrigeration capacity demand by increasing the fan speed, which ultimately has the result that a higher refrigeration capacity is provided. This enables the use of a compressor with a comparatively low refrigeration capacity. A further advantage of the reduction of the fan speed consists of the fact that the electrical power consumption of the fan and thus the energy consumption of the unit are reduced with a comparatively low refrigeration capacity.

As stated above, the fan is preferably arranged on or in the region of an assembly carrier which is located in the unit base and on which one or more further components of the unit, preferably components for the generation of cold, are arranged.

Provision is made in a preferred embodiment of the invention that the unit has a compressor and/or a condenser and/or an evaporation tray which are arranged in the unit base and preferably on the assembly carrier.

The named detection means can be made such that they measure one or also a plurality of operating parameters of the unit. It is thus conceivable that the fan speed and/or the direction of rotation of the fan depend on one or also a plurality of operating parameters such as the opening frequency of the door or flap or drawer and the opening duration of the door or flap or drawer of the unit.

The at least one operating parameter can, for example, be the compressor speed and/or the running times and idle times of the compressor and/or the relative switch-on duration of the compressor. It is, for example, conceivable that in conjunction with a speed-regulated compressor, the fan speed is regulated in dependence on the compressor speed.

The at least one operating parameter can furthermore be the setting of the temperature regulator of the unit. If the user sets the temperature regulator of the unit to a high value, that is, if a high refrigeration capacity is required, provision can be made that the fan speed is set comparatively high until the temperature is reached, or even for longer. If, in contrast, a lower regulator setting is selected, that is, if only a low refrigeration requirement is demanded, provision can be made that the fan is operated at a comparatively low speed.

Provision is made in a further embodiment of the invention that the at least one operating parameter is the condensing temperature. If, for example, the condensing temperature is in a non-permissibly high range in the case of contamination of the condenser, the fan speed can be increased accordingly.

Provision can furthermore be made that the at least one operating parameter is the temperature and/or the temperature change or its speed and/or or the humidity and/or the humidity change of the space of the unit to be chilled.

Provision can be made in a further embodiment of the invention that the speed and/or the direction of rotation of the fan depend on the operating state of the unit. If, for example, the unit is in the defrosting phase, provision can be made that the fan speed is increased for a specific duration of time or for the duration of time of the defrosting phase and that subsequently the fan is again operated at the rated speed.

Provision is made in a further embodiment of the invention that the operating parameter is the number and/or the duration of openings of the doors or flaps. It is thus conceivable, for example, to set a corresponding blower speed in dependence on the door openings or on the door opening duration.

The detection means can alternatively or additionally also be made such that they do not detect parameters directly relating to the unit, but rather parameters of the ambient atmosphere. For example, the detection of the ambient temperature and/or of the humidity of the unit environment is/are conceivable.

It is furthermore conceivable that the detection means are made such that they detect the temperature in the assembly space, for example the temperature of an assembly carrier and/or in an exhaust air passage of the unit.

The above statements generally relate not only to the fan speed, but rather additionally also apply accordingly or alternatively to the direction of rotation of the fan.

The only FIGURE shows the rear side of a unit with a base assembly in a schematic view.

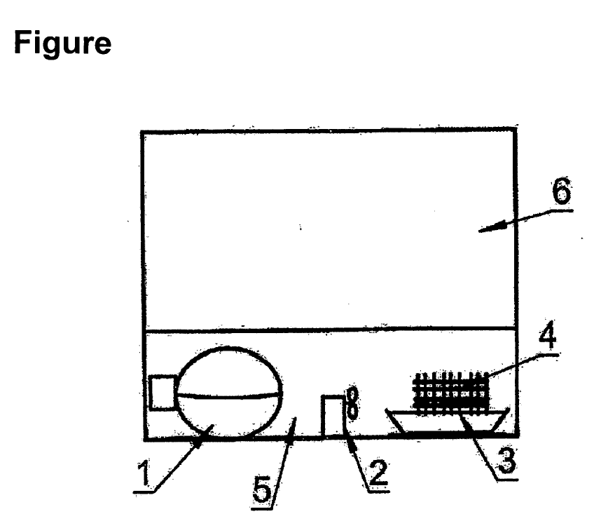

FIG. 1 shows the refrigerator unit and/or the freezer unit 6 with the unit base assembly 5. There are located on this base assembly, which can be inserted into the unit 6 and which can be removed from the unit, in the embodiment shown in the FIGURE: a compressor 1, a fan 2, an evaporation tray 3 and a condenser 4.

The unit furthermore comprises detection means which are not shown in any more detail and by means of which one or more parameters relating to the unit or also to the unit environment can be detected. A control and/or regulation unit is furthermore provided which can, for example, detect the following operating states and can control the fan accordingly.

If, for example, the parameter “ambient temperature” is detected, provision can be made that the fan 2 is operated at low speed at a low ambient temperature and is operated at a comparatively high speed at a high ambient temperature due to the higher required refrigeration capacity.

If the parameter “compressor speed” is measured, the fan speed can be regulated in dependence on the compressor speed, in particular in conjunction with a speed-regulated compressor.

If, for example, the parameter “running times and idle times of the compressor” is measured, a corresponding fan speed can be used in dependence on this parameter. The same applies accordingly to the parameter “relative switch-on duration of the compressor”.

It is also possible to measure the number and/or the duration of the openings of the door or flap and to select the fan speed in dependence on this number and/or on the duration. With a large number of door openings or a long door opening duration, a higher fan speed will be necessary due to the increased heat input into the space to be chilled than with comparatively few door openings or a short door opening duration.

A further parameter can be the “regulator setting”. The fan speed can be set in dependence on the regulator setting set by the user. With a “warm regulator setting”, i.e. with a low refrigeration capacity, the fan can be operated at a low speed and with a “cold regulator setting”, i.e. at a high refrigeration capacity, the fan can be operated at a high speed.

It is also conceivable to detect the operating state to the effect whether the unit is in a defrosting phase. It is conceivable to increase the fan speed for a specific time duration before and directly after a defrosting phase. The unit can subsequently again be operated at the rated speed.

A further parameter is the temperature increase in the unit. In this case, it is not the temperature value per se which is detected, but rather the speed at which the temperature value changes. If, for example after one or more door openings, there is a fast temperature increase in the unit, the blower speed is increased.

It is also conceivable to vary the speed of the fan in dependence on the relative humidity.

As stated above, a further parameter is the condensing temperature. If there is a contamination of the condenser or if the condensation temperature is in a non-permissibly high range, the fan speed can be increased.

As stated above, the above statements do not only apply to the fan speed, but alternatively or additionally also to the direction of rotation of the rotor of the fan. There is in particular the possibility with a DC fan to reverse the direction of rotation of the rotor and thus also the direction of flow. The contamination of the condenser by dust, for example, can thereby be prevented or reduced. Such a reversal of flow direction can take place automatically at regular intervals, manually or, in dependence on one or more of the measured parameters.

1. A refrigerator unit and/or a freezer unit (6) comprising a unit base and a fan (2) for the generation of an airflow in the unit base, wherein the unit has a control or regulation unit by which the speed and/or the direction of rotation of the fan (2) can be changed.

2. A refrigerator unit and/or a freezer unit (6) in accordance with claim 1, wherein the control or regulation unit is made such that it sets the speed and/or the direction of rotation of the fan (2) according to stored parameters.

3. A refrigerator unit and/or a freezer unit (6) in accordance with claim 1, wherein the unit comprises detection means for the detection of at least one parameter; and the control or regulation unit is made such that it changes the speed and/or the direction of rotation of the fan (2) in dependence on the at least one measured parameter.

4. A refrigerator unit and/or a freezer unit (6) in accordance with claim 1, wherein the fan (2) is arranged on an assembly carrier (5) which is located in the unit base and on which one or more further components of the unit (6) are arranged.

5. A refrigerator unit and/or a freezer unit (6) in accordance with claim 1, wherein the unit comprises at least one compressor (1) and/or at least one condenser (4) and/or at least one evaporation tray (3) which are arranged in the unit base.

6. A refrigerator unit and/or a freezer unit (6) in accordance with claim 3, wherein the detection means are made such they measure one or more operating parameters of the unit (6).

7. A refrigerator unit and/or a freezer unit (6) in accordance with claim 6, wherein the at least one operating parameter is the compressor speed and/or the running times and idle times of the compressor (1) and/or the relative switch-on duration of the compressor (1).

8. A refrigerator unit and/or a freezer unit (6) in accordance with claim 6, wherein the at least one operating parameter is the setting of the temperature regulator of the unit (6).

9. A refrigerator unit and/or a freezer unit (6) in accordance with claim 6, wherein the at least one operating parameter is the condensing temperature.

10. A refrigerator unit and/or a freezer unit (6) in accordance with claim 6, wherein the at least one operating parameter is the temperature and/or the temperature change and/or the humidity and/or the humidity change of the space of the unit (6) to be chilled.

11. A refrigerator unit and/or a freezer unit (6) in accordance with claim 6, wherein the at least one operating parameter is an operating state of the unit (6), with the operating state including the states “defrosting phase” and “normal operation”.

12. A refrigerator unit and/or a freezer unit (6) in accordance with claim 6, wherein the at least one operating parameter is the number and/or the duration of the openings of the door and/or flap and/or drawer.

13. A refrigerator unit and/or a freezer unit (6) in accordance with claim 3, wherein detection means are made such that they detect the ambient temperature and/or the humidity of the unit environment.

14. A refrigerator unit and/or a freezer unit (6) in accordance with claim 3, wherein detection means are made such that they detect the temperature in the assembly space and/or in an exhaust air passage.

15. A refrigerator unit and/or a freezer unit (6) in accordance with claim 4, wherein the unit comprises at least one compressor (1) and/or at least one condenser (4) and/or at least one evaporation tray (3) which are arranged in the unit base and on the assembly carrier (5).

16. A refrigerator unit and/or a freezer unit (6) in accordance with claim 2, wherein the unit comprises means for the detection of at least one parameter; and the control or regulation unit is made such that it changes the speed and/or the direction of rotation of the fan (2) in dependence on the at least one measured parameter.

17. A refrigerator unit and/or a freezer unit (6) in accordance with claim 16, wherein the fan (2) is arranged on an assembly carrier (5) which is located in the unit base and on which one or more further components of the unit (6) are arranged.

18. A refrigerator unit and/or a freezer unit (6) in accordance with claim 2, wherein the fan (2) is arranged on an assembly carrier (5) which is located in the unit base and on which one or more further components of the unit (6) are arranged.

19. A refrigerator unit and/or a freezer unit (6) in accordance with claim 3, wherein the fan (2) is arranged on an assembly carrier (5) which is located in the unit base and on which one or more further components of the unit (6) are arranged.

20. A refrigerator unit and/or a freezer unit (6) in accordance with claim 4, wherein the detection means are made such they measure one or more operating parameters of the unit (6).
